(19) United States
(12) Patent Application Publication
(10) Pub. No.: US 2020/0178552 A1
(43) Pub. Date: Jun. 11, 2020

(54) FRESH PASTA FILATA CHEESE WITHOUT FATS AND CORRESPONDING PRODUCTION PROCESS

(71) Applicant: Minaba Tech S.R.L., Manfredonia (IT)

(72) Inventors: Amalia Conte, Foggia (IT); Cristina Costa, San Severo (IT); Matteo Alessandro Del Nobile, Manfredonia (IT); Annalisa Lucera, Foggia (IT)

(73) Assignee: Minaba Tech S.R.L., Manfredonia (IT)

(21) Appl. No.: 16/335,236

(22) PCT Filed: Sep. 25, 2017
(86) PCT No.: PCT/IB2017/055800

§ 371 Date: Mar. 20, 2019

(30) Foreign Application Priority Data
Sep. 26, 2016 (IT) 102016000096332

(51) Int. Cl. A23C 19/068; A23C 19/093; A23L 29/10; A23L 33/115

(52) U.S. Cl. CPC A23C 19/0684; A23C 19/093; A23V 2002/00; A23L 33/115; A23C 2250/25; A23L 29/10

(57) ABSTRACT

Fresh pasta filata cheese with a fat content equal to or lower than 0.5% w/w comprising a curd of fully skimmed milk and at least one vegetable oil and production process thereof.

### FIELD OF INVENTION

This disclosure relates to a fresh pasta filata cheese (string cheese) substantially fat free and production process thereof.

### TECHNOLOGICAL BACKGROUND

Fiordilatte is a fresh cheese made of whole cow milk, which belongs to the group of pasta filata cheeses. Fiordilatte is a typical Italian dairy product and it is well known in all the world. Fiordilatte hasn't rind, but it has a soft skin with white, smooth and gloss surface. The internal structure is fibrous, soft and elastic. In the nutritional composition of fiordilatte is found a high concentration of fatty acids (about 20%, 13% of which consisting of saturated fatty acids) and cholesterol (about 60 mg/100 g) that, as it is known by various medical studies, represent one of the major risks of the onset of obesity, cardiovascular diseases and tumours.

Currently, fiordilatte cheeses with reduced fat content, that are produced by partially skimmed milk, are commercially available however, there aren't pasta filata products made of full skimmed milk that are able to equal the structural and sensory characteristics of the traditional fiordilatte.

For example, “light” fiordilatte has half fat content compared to the traditional fiordilatte. A low-fat mozzarella was produced using, as raw materials, skimmed milk powder, caseins, melting salts and structuring agents [NZ-A-619252].

Example presented in literature report the addition of structuring agents (gums and starches) into skimmed milk to manufacture low-fat pasta filata products to be used as top ingredient for pizza (Johnson et al., 2009; Drake and Swanson, 1995].

The different strategies identified up to now improve only some aspects of this dairy product, such as the ability to go stringy and melt on the pizza, but completely ignore the possibility of realizing a product for fresh consumption.

Some patents suggest useful technologies to replace completely or in part the milk fat with vegetable fats, however this solution, wholly or partially, was used to produce soft and hard cheeses but it wasn't used to produce pasta filata cheese [LT-B-5814].

Another patent relates to the use of high-speed mixers, commonly used in the food industry, to homogenize fatty acids from olive oil, in order to produce a fat-replaced milk helpful to produce different types of curds [US-A-2010/143537].

### SUMMARY OF THE INVENTION

Taking into account these considerations, the purpose of the invention is to make a pasta filata cheese substantially fat free for fresh consumption.

According to the invention, the abovementioned aim is obtained with the solution specifically reported in the attached claims, which are un integral part of this disclosure.

An embodiment of this disclosure relates to a fresh pasta filata cheese with a fat content equal to or lower than 0.5% w/w, including a curd of fully skimmed milk and at least one vegetable oil.

A different embodiment relates to a process for producing a fresh pasta filata cheese with a fat content equal to or lower than 0.5% w/w, comprising the following steps:

i) preparing an emulsion by mixing at least one vegetable oil and at least one emulsifying agent;
ii) mixing the emulsion of the step i) with fully skimmed cow milk;
iii) acidifying the mixture of step ii) to obtain an acidified mixture;
iv) coagulating the acidified mixture to obtain a curd;
v) processing the curd to obtain a fresh pasta filata cheese with a fat content equal to or lower than 0.5% w/w.

### SHORT DESCRIPTION OF THE DRAWINGS

The invention will now be described in detail, as a non-limiting example, with reference to the attached drawings:

FIG. 1: Taste, visual, olfactory and tactile perceptions of the different types of fiordilatte.

FIG. 2: Evolution of overall quality for the different types of fiordilatte stored at 4° C.

### DETAILED DESCRIPTION OF THE INVENTION

In the following description, numerous specific details to provide a complete knowledge of the different embodiments are presented. The embodiments can be practically implemented without one or more of the specific details, or with other processes, components, materials, etc. In other cases, well-known structures, materials, or operations are not described in detail to avoid obscuring certain aspects of the embodiments.

In all this report, the reference to “an embodiment” or “embodiment” means that a particular peculiarity, structure, or characteristic described in connection with the embodiment is included in at least one embodiment. Then, expressions as “in an embodiment” or “in one embodiment” in various places throughout the present specification do not necessarily always refer to the same embodiment. Moreover, the particular peculiarities, structures, or features may be combined in any way suitable for one or more embodiments.

The titles used herein are only for convenience and do not interpret the scope or the meaning of the different embodiments.

As anticipated at the beginning, the disclosure aim is to provide a pasta filata cheese substantially fat free, said cheese being preferably intended for fresh consumption.

In an embodiment, this disclosure relates to a pasta filata cheese with a fat content equal to or lower than 0.5% w/w comprising a curd of fully skimmed milk and at least one vegetable oil and optionally at least one structuring agent.

This disclosure relates to a pasta filata cheese, also known as fiordilatte, nutritionally more balanced and substantially without fat (“fat-free”) obtained from fully skimmed milk.

Currently, the recommended maximum dose for assumption of saturated fats, in the daily diet, is equal to values less than 10% of the calories daily introduced with the diet; however, the consumption of saturated fats in Europe is still high compared to the suggested values (about 15% of calories) [Rioux and Legrand, 2007].

Therefore, this disclosure relates to a pasta filata cheese that can be called as “fat-free” on the basis of the Regulation (EC) N. 1924/2006 specifying that a foodstuff can be named as “fat-free” when the fats content is no more than 0.5 g for 100 g or 100 ml of product.

The pasta filata cheese of the present disclosure includes a vegetable oil as fat instead of the fat fraction of cow milk. The selection of the vegetable oil was made considering the nutritional, technological and sensory characteristics of the final product.

In an embodiment, the vegetable oil usable for making pasta filata cheese, object of this disclosure, has a lipid fraction rich in monounsaturated and/or polyunsaturated fatty acids. In an embodiment, the vegetable oil has a lipid fraction containing at least 70% w/w, preferably at least 80% w/w, of monounsaturated and/or polyunsaturated fatty acids. In an embodiment, at least one vegetable oil is selected from corn oil, olive oil (preferably extra virgin olive oil), rice oil. In a preferred embodiment the vegetable oil is rice oil.

The rice oil has represented the type of vegetable fat able to obtain the best compromise between nutritional, technological and sensory characteristics of the final product.

The present inventors believe that rice oil can be a good substitute for animal fat, helping to the creation of a correct interaction between caseins and lipids, and at the same time improves the lipid profile of the product due to the abundance of unsaturated fatty acids and Vitamin E.

The lipid composition of rice oil is characterized on average by saturated (17%), monounsaturated (42%) and polyunsaturated (39%) fatty acids. Between the unsaturated fatty acids, linoleic acid (C18:2 of the omega 6 series) takes on particular importance within healthy and balanced diets, it contributes to maintain normal cholesterol levels.

Moreover, rice oil is one of the richest oils of unsaponifiable fraction (sterols, tocopherols, tocotrienols); among these elements vitamin E and gamma-orizanol emerge, known for their antioxidant properties.

The addition of vegetable origin fatty acids, without the use of homogenizers that would lead to an increase in costs for dairies, represents another remarkable advantage in the production of this new type of fiordilatte.

In an embodiment, the pasta filata cheese also comprises at least one emulsifying agent.

In fact, the present inventors have found one better mixing of vegetable oil with milk when vegetable oil is used in the form of emulsion. To this aim, several emulsifiers have been tested, such as soy milk, soy lecithin, mono- and di-glycerides of fatty acids.

The emulsion obtained by mixing the emulsifier properly solubilized with vegetable oil was distributed in homogeneous manner in the milk. The addition of at last one vegetable oil in form of emulsion allowed to impart softness to the product.

In an optional embodiment, the soy milk permitted to obtain a stable emulsion with rice oil because it contains a natural emulsifier (soy lecithin).

In an embodiment, the pasta filata cheese also comprises at least one structuring agent.

To give to the pasta filata cheese the right consistency, the inventors of the present application have studied the addition of at least one structuring agent selected, for example, from fructans, hydrocolloids and gums that have proved to improve both the fibrousness and graininess of pasta filata cheese.

In an optional embodiment, at least one structuring agent is selected from fructans; in a preferred embodiment, the structuring agent is inulin.

The inulin is a food ingredient that belongs to the class of fructans. Nutritionally it has functional properties as food fibre with prebiotic activity. Inulin is increasingly used in dairy products as prebiotic and dietary ingredient, but to date it has never been used in the process production of fat-free fiordilatte.

In a particularly preferred embodiment of the present invention, the pasta filata cheese was made of fully skimmed milk added with rice oil, appropriately carried with soy milk and inulin.

A different embodiment of the present disclosure relates to a producing process of a pasta filata cheese for fresh consumption, with a fat content equal to or lower than 0.5% w/w comprising the following steps:

i) preparing an emulsion by mixing at least one vegetable oil and at least one emulsifying agent;

ii) mixing the emulsion of step i) with fully skimmed cow milk;

iii) acidifying, optionally by heating, the mixture of step ii) to obtain an acidified mixture;

iv) coagulating the acidified mixture to obtain a curd;

v) processing the curd to obtain a pasta filata cheese with a fat content equal to or lower than 0.5% w/w.

In an embodiment, the step i) provides the mixing of one emulsifying agent (preferably soy milk) in an amount between 40 and 55% by weight and one vegetable oil in an amount between 25 and 45% by weight with respect to the total weight of the mixture. Optionally, a vegetable starch is added to this mixture, preferably potato starch, in an amount ranging from 5 to 10% w/w.

In one or more embodiments, in the step i) at least one structuring agent is added; preferably, the at least one structuring agent is present in an amount between 15 and 25% by weight with respect to the total weight of the mixture.

In one or more embodiments, the step i) provides the heating of the at least one emulsifying agent at a temperature between 75 and 85° C., preferably 80 and 82° C., and the addition of the structuring agent (preferably inulin).

In one or more embodiments, the step i) provides the mixing of at least one vegetable starch with at last one emulsifying agent at a temperature ranging from 55 to 65° C., preferably from 60 to 62° C., and then the addition of the vegetable oil to form the emulsion.

In one embodiment, the step ii) provides the mixing of the emulsion obtained during the step i) with fully skimmed cow milk in an amount between 2.5 and 5% by weight with respect to the volume of the cow milk.

In one or more embodiments, the step iii) provides the addition of a) an acidifying agent, such as citric acid, lactic acid, acetic acid, to obtain a pH value of the mixture between 5.60 and 6.30, preferably between 5.72 and 6.20 and/or b) a microbial culture such as Streptococcus thermophilus, Lactobacillus bulcaricus. When a microbial culture is added, the mixture is preferably heated to a temperature between 33 and 40° C., more preferably about 35-38° C. The a) and/or b) options depend on the preference for chemical, microbial or mixed acidification.

In one or more embodiments, the microbial culture (preferably Streoptococcus thermophilus in lyophilized form), to carry out the acidification, is added in an amount ranging from 3 g to 5 g per 100 l of mixture.

In one or more embodiments, the acidifying agent is added to the mixture of the step ii) in an amount between 0.2 and 0.6% w/w.

In one embodiment, the coagulation step iv) is carried out by adding liquid rennet to the acidified mixture obtained in step iii). Optionally, in one or more embodiments, the liquid rennet is added to the acidified mixture in an amount between 0.015 and 0.020% v/v.

In one embodiment, the step iv) is conducted until the curd pH reaches a value between 5.0 and 5.25, preferably 5.18-5.20.

In one embodiment, the step iv) provides a ripening of the curd under whey; preferably, this step is carried out for a time between 1 and 5 hours, more preferably between 1.5 and 3 hours.

In one embodiment, the step v) provides the processing of the curd according to techniques known to the skilled person, such as kneading, stretching and subsequent shaping.

The pasta filata cheese obtained from fully skimmed milk, with vegetable oil added, with and without the addiction of structuring agent was compared to traditional fiordilatte (from whole milk) and fiordilatte from fully skimmed milk without vegetable fats. This comparison was carried out by nutritional, sensorial, microbiological and colorimetric analyses conducted just after the production.

In a sequential step, to evaluate microbiological and sensorial quality during storage respect to control fiordilatte, the pasta filata cheese, object of the present disclosure, was packaged in trays with pickling liquid and stored at 4±1° C. e 8±1° C.

As non-limiting example, the steps of production process of pasta filata cheese, object of the present invention, shelf life tests and related results were reported below.

### Materials and Methods

Fiordilatte from Fully Skimmed Milk (SO)

The production process of fiordilatte from fully skimmed milk and with rice oil added has provided for the preparation of a soy milk and rice oil based emulsion, solubilization of the emulsion in the milk, biological acidification and coagulation of the milk, ripening of the curd, mixing-stretching, shaping and firming of samples.

The emulsion (hereinafter also called vegetable cream) is obtained from soy milk realized by using methods known in the art. Briefly, 100 g of soy beans (Farina Sprint, Cesena, Italy) were put into water for 24 hours, rinsed and chopped with water in a ratio of 1:4 in weight. The mash obtained was boiled with the addition of 1 l of water; the solution was filtered and the milk was obtained.

For the preparation of the vegetable cream 53.23% soy milk, 39% oil rice (Scotti, Pavia, Italy), 7.77% potato starch (Paneangeli, Brescia, Italy) were used. The starch was added and mixed with the soy milk at a temperature ranging between 60 and 62° C. and the emulsion was obtained by using an immersion blender by adding rice oil slowly.

Then, 100 l of fully skimmed cow milk (0.1% fats) with initial pH value of 6.8 were put in a stainless steel boiler (MilkyLab, Modena, Italy), added with 3.25% (w/v) of soy cream and mixed.

After complete blending, the milk was heated to the temperature of about 38° C. to add the ferment for the acidification, a commercial starter culture represented by Streptococcus thermophilus (ST-13, CHR HANSEN, Denmark). When the milk pH reached a value of 6.2, the temperature was brought to 36° C. and 18 ml of rennet liquid, (CHY-MAX® Plus, CHR HANSEN, Denmark, Activity 200 IMCU/ml) diluted with water in a ratio of 1:1 were added to achieve the milk coagulation step.

After 20 minutes, the curd was broken and ripened under whey for about 2 hours, until the pH reached the value of 5.18-5.20. Then, the whey was removed.

The obtained curd was placed on the draining table where it was left the time needed to eliminate further serum and compact.

After that, the curd was kneaded and stretched with stretching machine (MilkyLab, Modena, Italy). During kneading, 10 kg of curd, 3.5 l of hot water and 212 g of salt were used; the process was conducted to the temperature of 65° C. for 4.5 minutes; successively, small fiordilatte cheeses of about 50 g were obtained and putted in a firming tank for about 3 hours.

### Fiordilatte from Fully Skimmed Milk with Inulin Added (SOI)

In order to validate the fat-free product, inulin was used as structuring agent.

Initially, the inulin used for producing fiordilatte was added to the emulsion of soy milk and rice oil. In particular, soy milk (43.4%), inulin (22.5%) (Orafti, HP), rice oil (28.5%) (Scotti, Pavia, Italy), potato starch (5.6%) (Paneangeli, Brescia, Italy) were used.

The cream was prepared by heating the soy milk at temperature of 80° C. to solubilize the inulin by means of an immersion blender. Then, the temperature was lowered to 60-62° C. for incorporating potato starch; afterward, the emulsion was prepared by adding the rice oil slowly and by blending it.

Fully skimmed cow milk (100 l) (0.1% fats) with a pH value of 6.8 was put in a stainless steel boiler (MilkyLab, Modena, Italy) for processing. To dissolve homogeneously the cream, a part of tepid milk (about 5 litres; temperature about 38° C.) was used.

The fiordilatte production provided a mixed acidification process, previously tested and compared to chemical and microbial acidification. A good compromise between the structural, sensory and preservative characteristics of the product was obtained with mixed acidification.

In particular, the milk with vegetable cream was acidified with a citric acid solution (10% w/w) up to pH 6.12; then, the milk was heated to the temperature of 38° C. and the starter culture previously revitalized (Streptococcus thermophilus ST-13, CHR HANSEN, Denmark) was added. After shaking for 20 minutes, the rennet was added (for milk coagulation) and then, as described above, the curd ripening, stretching and shaping steps were conducted.

During the kneading and stretching steps some changes were made. In particular, the stretching temperature was set to 80° C., a mixture pre-heating step (3 minutes) in the fuser with fixed augers was done. Then, salt (212 g) was added to 10 kg of curd and the kneading-stretching process was started by activating the augers without water. When the curd reached the stretching point, the mixture was formed in small fiordilatte cheeses of about 50 g, that were putted in a firming tank. The total stop was for about 3 hours.

### Fiordilatte from Whole Milk (CNT1) and from Fully Skimmed Milk (CNT2)

Fiordilatte from whole milk (CNT1) and fiordilatte from fully skimmed milk (CNT2) were obtained by chemical acidification process. In particular, the production technology comprised several sequential steps: chemical acidification using lactic acid diluted with water (70/30 v/v) up to pH 5.72 and 5.86 for whole milk and fully skimmed milk, respectively, milk coagulation, ripening of the curd under whey, kneading-stretching (80° C.), shaping and firming.

### Colour Analysis

The colour of the external and internal surface of fiordilatte was measured using a tristimulus colourimeter Chroma Meter-2 CR-300 (Minolta, Osaka, Japan). The measuring area was 8 mm. The instrument was calibrated against a standard white tile and C was the illuminant used for colour evaluation. L* (lightness), a* (redness/greenness index, +/−) and b* (yellowness/blueness index, +/−) values were measured. Results were recorded as mean of three measurements.

### Microbiological Analyses

Microbiological analyses were related to the research of the following microbial groups: total bacterial count (CBT), Pseudomonas spp., Enterobacteriaceae, lactic acid bacteria, lactococci and yeasts.

The media and the conditions used for the microbial count were the following: Plate Count Agar (PCA, Oxoid, Milano, Italy) incubated at 30° C. for 24-48 h for CBT; Pseudomonas Agar Base (PAB, Oxoid), added with CFC selective supplement, incubated at 25° C. for 48 h for count of Pseudomonas spp.; for Enterobacteriaceae Violet Red Bile Glucose Agar (VRBGA, Oxoid) incubated at 37° C. for 18-24 h was used; de Man Rogosa Sharpe agar (MRS, Oxoid) incubated under anaerobic conditions at 37° C. for 2-4 days for lactic acid bacteria; M17 agar (Oxoid) incubated under anaerobic conditions at 37° C. for 48 h for lactococci; for yeasts Sabouraud Dextrose Agar (SDA, Oxoid), supplemented with chloramphenicol was used and incubated at 25° C. for 48 h.

### Sensorial Analyses

Qualified assessors carried out sensory evaluation of fiordilatte samples (panel test). The panelists were also asked to judge the colour, odour, taste and texture characteristics of fiordilatte cheese samples. Moreover, the overall quality of the sample, intended as an average of the sensory attributes was evaluated.

To describe the differences between samples it was used a sensorial evaluation scale from 0 (very bad) to (excellent), wherein a score of 4 was the minimum threshold value for the sensorial acceptability (Corradini e Innocente, 2002).

### Nutritional Analysis

The analysis of the nutritional composition of the new fiordilatate samples provided for the determination of the percentage of proteins, carbohydrates, fats, vitamins (B2, A, E) and mineral salts (Ca, P, Na). Particular attention has been paid to lipid composition within which total cholesterol, saturated, monounsaturated and polyunsaturated fatty acids were determined. The same analyzes have also been conducted on traditional whole milk fiordilatte (CNT1) to evaluate the actual nutritional improvement.

The determination of the inulin content in the fiordilatte samples with inulin was performed using a Fructan-HK enzymatic kit (K-FRUCHK, Megazyme, Wicklow, Ireland 2014) with spectrophotometric reading of the absorbance at 340 nm. The determined values were expressed as g of inulin/100 g of product.

### Results

### Quality of the Innovative Fiordilatte Compared to the Traditional One

The analyses carried out on the different fiordilatte cheese types (CNT1, CNT2, SO and SOI) highlighted that the developed process allows to obtain a fiordilatte cheese with structural and sensory characteristics similar to the traditional one, but nutritionally better. In Table 1 are reported L*, a* and b* values for the different fiordilatte cheese types analyzed.

In particular, the instrumental analyses show that the samples with inulin (Tables 1 and 2) have lightness (L*), green index (a*) and yellow index (b*) more similar to the traditional fiordilatte (CNT1). On the contrary, the product obtained from fully skimmed milk, without the addition of vegetable cream (CNT2), has lower L* and b* values, resulting a less brilliant white than the other samples.

TABLE 1

| Samples | L* ₍ₒᵤₜₑᵣ₎ | a* ₍ₒᵤₜₑᵣ₎ | b* ₍ₒᵤₜₑᵣ₎ |
|---|---|---|---|
| CNT1 | 94.95 ± 0.18^{a} | −1.95 ± 0.18^{a} | 9.72 ± 0.58^{a} |
| CNT2 | 87.96 ± 0.43^{b} | −2.17 ± 0.04^{a} | 4.85 ± 0.25^{b} |
| SO | 91.19 ± 0.48^{c} | −2.29 ± 0.26^{a} | 7.35 ± 0.62^{c} |
| SOI | 92.18 ± 0.30^{d} | −2.05 ± 0.12^{a} | 7.26 ± 0.32^{c} |

TABLE 2

| Samples | L* ₍ᵢₙₙₑᵣ₎ | a* ₍ᵢₙₙₑᵣ₎ | b* ₍ᵢₙₙₑᵣ₎ |
|---|---|---|---|
| CNT1 | 92.94 ± 0.20^{a} | −2.90 ± 0.04^{a} | 13.64 ± 0.23^{a} |
| CNT2 | 83.62 ± 0.38^{b} | −2.70 ± 0.27^{a} | 8.98 ± 0.70^{b} |
| SO | 87.26 ± 0.32^{c} | −3.77 ± 0.01^{b} | 11.48 ± 0.09^{c} |
| SOI | 88.35 ± 0.43^{d} | −3.98 ± 0.13^{b} | 13.18 ± 0.49^{a} |

^{a-d}Different superscripts in the same column mean that the samples are statistically different (STATISTICA 7.1).

The microbiological analysis highlights that the initial cell loads of the different products are comparable. In particular, yeasts, Enterobacteriaceae and Pseudomonas spp., were below the detection limit. Values of about 5 log cfu/g were found for the total bacterial count, the obtained values are attributable to the natural microflora of the milk.

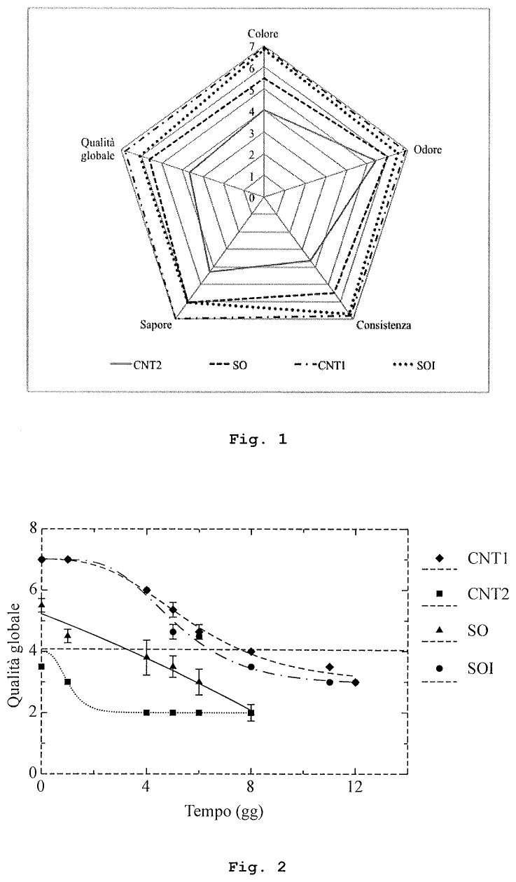

From the sensory analyses it was possible to express the taste, visual, olfactory and tactile perceptions of the different types of fiordilatte (FIG. 1).

As can be seen in FIG. 1, the SOI sample has sensory characteristics very similar to the fiordilatte from whole milk (CNT1); on the contrary, the sample produced only with skimmed milk (CNT2) has sensory attributes below the acceptability limit (colour, flavour, consistency and overall quality) except for the odour that was not unpleasant, however it was different from a traditional product. In addition, it is important to note that the addition of inulin (SOI) improves the texture characteristics of fiordilatte, making them more similar to a fiordilatte from whole milk.

Table 3 shows the nutritional values of fiordilatte from whole milk (CNT1) and fiordilatte from fully skimmed milk (SO).

TABLE 3

| | | | For 100 g of | |
|---|---|---|---|---|
| | For 100 g of | | fiordilatte from | |
| Mean | fiordilatte from whole | | fully skimmed | |
| Nutritional values | milk (CNT1) | | milk (SO) | |
| Protein | 21.30% | | 22.30% | |
| Carbohydrates | 18.80% | | 34.90% | |
| Total fats | 7.60% | | 0.30% | |
| of which: | | | | |
| saturated | 67.91% | | 24.44% | |
| monounsaturated | 28.21% | | 42.47% | |
| polyunsaturated | 3.89% | | 33.08% | |
| Calcium | 5123.2 | mg/100 g | 4318.4 | mg/100 g |
| Phosphorus | 1669.0 | mg/100 g | 1621.8 | mg/100 g |
| Sodium | 1436.4 | mg/100 g | 2988.6 | mg/100 g |
| Cholesterol | 67.0 | mg/100 g | 6.2 | mg/100 g |
| Vitamin A | 9260 | I.U./kg | N.R. I.U./kg | |
| Vitamin B2 | 0.24 | mg/100 g | 0.25 | mg/100 g |
| Vitamin E | 3.37 | mg/kg | 49.10 | mg/kg |

As can be seen in Table 3, the new product presents a remarkable reduction in fat content; in particular, values of 7.60% and 0.30% were obtained for the CNT1 sample and the new fiordilatte, respectively. In addition, the lipid profile analyses show a percentage increase in monounsaturated and polyunsaturated fatty acids for fiordilatte from fully skimmed milk. It is important to point out that there is also a 10 fold reduction in cholesterol content compared to the classical whole milk fiordilatte (6.20 mg/100 g and 67.0 mg/100 g, respectively) and a considerable increase in content of vitamin E (3.37 mg/kg in traditional fiordilatte to 49.10 mg/kg in the innovative one).

From inulin content analyses on all 4 product types, values of 0 for control samples (CNT1, CNT2) and for samples without inulin (SO) were obtained, while a value of 1.75% was found in the fiordilatte sample from fully skimmed milk with inulin (SOI).

### Fiordilatte Quality During the Storage

In order to give completeness to the proposed idea, a shelf life test at 4±1 ° C. and 8±1° C. was carried out on the different dairy products that were obtained.

As expected, microbiological analyses shown that the lower storage temperatures better control the spoilage microorganisms.

In particular, the principal spoilage microorganisms of dairy products (Pseudomonas spp.) were below the imposed limit for all the storage period for the different types of fiordilatte stored at 4° C., while a progressive increase of Pseudomonas spp. was observed for all samples stored at 8° C. that exceeded the limit value (6 log cfu/g) after about 5 days. For Pseudomonas spp., a value of 6 log cfu/g has been set, since literature studies suggest that, at that concentration, sensory alterations such as the appearance of abmormal odors and colors make the product unacceptable (Wiedmann et al., 2000; Giaccone et al., 2010).

Tables 4 and 5 show the monitored microbial loads (total bacterial count—CBT, lactic acid bacteria, Enterobacteriaceae in Table 4 and lactococci and yeasts in Table 5) for samples of fiordilatte SO stored at the two tested temperatures.

TABLE 4

| | CBT | | Lactic acid bacteria | | Enterobacteriaceae | |
|---|---|---|---|---|---|---|
| Time | (log cfu/g) | | (log cfu/g) | | (log cfu/g) | |
| (days) | 4° C. | 8° C. | 4° C. | 8° C. | 4° C. | 8° C. |
| 0 | 4.45 ± | 4.45 ± | 5.58 ± | 5.58 ± | 1.00 ± | 1.00 ± |
| | 0.01 | 0.01 | 0.14 | 0.14 | 0.00 | 0.00 |
| 1 | 5.27 ± | 5.51 ± | 5.68 ± | 5.63 ± | 1.00 ± | 1.00 ± |
| | 0.03 | 0.27 | 0.04 | 0.00 | 0.00 | 0.00 |
| 4 | 5.82 ± | 5.02 ± | 6.06 ± | 5.91 ± | 1.00 ± | 4.26 ± |
| | 0.06 | 0.14 | 0.13 | 0.04 | 0.00 | 0.17 |
| 5 | 5.78 ± | 5.95 ± | 5.66 ± | 5.35 ± | 1.00 ± | 4.94 ± |
| | 0.04 | 0.38 | 0.06 | 0.00 | 0.00 | 0.32 |
| 6 | 5.89 ± | 6.05 ± | 6.00 ± | 6.20 ± | 1.00 ± | 5.55 ± |
| | 0.25 | 0.25 | 0.00 | 0.27 | 0.00 | 0.38 |
| 8 | 5.80 ± | 6.08 ± | 6.45 ± | 6.57 ± | 1.00 ± | 5.40 ± |
| | 0.16 | 0.48 | 0.21 | 0.12 | 0.00 | 0.39 |

TABLE 5

| Time | Lactococci (log cfu/g) | | Yeasts (log cfu/g) | |
|---|---|---|---|---|
| (days) | 4° C. | 8° C. | 4° C. | 8° C. |
| 0 | 6.60 ± 0.01 | 6.60 ± 0.01 | 2.00 ± 0.00 | 2.00 ± 0.00 |
| 1 | 6.72 ± 0.01 | 6.75 ± 0.11 | 2.00 ± 0.00 | 2.00 ± 0.00 |
| 4 | 8.7 ± 0.00 | 8.76 ± 0.06 | 2.00 ± 0.00 | 2.00 ± 0.00 |
| 5 | 8.47 ± 0.00 | 8.53 ± 0.08 | 2.00 ± 0.00 | 2.00 ± 0.00 |
| 6 | 8.08 ± 0.08 | 8.53 ± 0.17 | 2.00 ± 0.00 | 2.00 ± 0.00 |
| 8 | 8.34 ± 0.04 | 8.55 ± 0.00 | 2.00 ± 0.00 | 2.00 ± 0.00 |

From Tables 4 and 5 it can be seen that the values determined for lactic bacteria and lactococci, microorganisms associated to the autochthonous microflora of the product and the use of the starter, have progressively increased over time and cell loads are comparable to the two temperatures. As for the typical lactic microflora of mozzarella, statistically comparable trends have been observed between the different products although, as was expected, in the control samples obtained by chemical acidification (CNT1 and CNT2) the cell loads of lactococci and lactobacilli were a little bit lower.

The microbial load of Enterobacteriaceae at initial time was below the detection limit for all samples; this demonstrates the good hygiene conditions adopted during the production process. The cellular load increased only in the samples stored at the highest temperature from the fourth day, while no microbial development at 4° C. was observed for the entire observation period. For the total bacterial count of the different types of fiordilatte, an increase from 4.5 log cfu/g to about 6 log cfu/g was found. Yeasts were below the detection limit throughout the storage period in all types of tested product.

FIG. 2 shows the evolution of global quality in function of storage time for the different tested fiordilatte samples stored at 4° C.

The overall quality of the control sample exclusively made from fully skimmed milk (CNT2) was below the acceptability limit immediately after production as the resulting product was hard with a yellow-pearly colour, and it was very different to a traditional fiordilate. For the control from whole milk (CNT1), a progressive loss of overall quality was observed, as a result of microbial proliferation that caused structural and odor changes to fiordilatte. The product has become unacceptable after about 1 week.

The qualitative decay of the new fiordilatte with inulin (SOI) was very similar to the control CNT1, thus demonstrating that the characteristics of the new fiordilatte are preserved over the time and ensure the acceptability of the product. The quality loss of fiordilatte with inulin was related to the change in structure and flavor of the product. For the sample without inulin (SO), there was a loss of overall quality due to rapid surface decay and changes in the internal structure which became more compact, assuming the appearance of semi-mature cheese.

In both types of fiordilatte with and without inulin (SOI and SO) the colour and odour parameters were above the acceptability limit for all the observation period, while the flavour gradually went down and the typical acidity, attributed by the starters, and the savoury were lost.

Obviously there was a loss of overall quality of all the analyzed products more quickly in the time when the storage occurred at 8° C. but, at that temperature, a similar trend for control CNT1 and for the new fat-free fiordilatte with inulin was recorded.

Table 6 shows the shelf life data of tested fiordilatte samples (SOI, SO, CNT1, CNT2) stored at 4° C., calculated as the limiting value between microbiological and sensory acceptability. These values were calculated using the re-parameterized Gompertz equation, taking into account for the microbiological aspect the evolution of Pseudomonas spp. (threshold value 6 log cfu/g) and for the sensory aspect the evolution of overall quality (limit 4), according to scientific literature (Conte et al., 2009).

TABLE 6

| | Microbial | Sensory | |
|---|---|---|---|
| | acceptability | acceptability | Shelf life |
| Samples | (days) | (days) | (days) |
| SOI | 8.75 ± 0.43 | 6.53 ± 0.33 | 6.53 ± 0.33 |
| SO | >8 | 3.42 ± 0.48 | 3.42 ± 0.48 |
| CNT1 | 8.3 ± 0.38 | 7.75 ± 0.34 | 7.75 ± 0.34 |
| CNT2 | >8 | — | — |

As can be seen in Table 6, shelf life for all samples was compromised by the sensory aspect. From the data it can be seen that the innovative fiordilatte (SOI) has conservability characteristics similar to those of fiordilatte from whole milk.

1. Fresh pasta filata cheese with a fat content equal to or lower than 0.5% w/w comprising a curd of fully skimmed milk and at least one vegetable oil.

2. Fresh pasta filata cheese according to claim wherein the at least one vegetable oil has a lipid fraction containing at least 70% w/w, preferably at least 80% w/w, of monounsaturated and/or polyunsaturated fatty acids. (Currently Amended) Fresh pasta filata cheese according to claim 1, further comprising at least one structuring agent.

4. Fresh pasta filata cheese according to claim 1, further comprising at least one emulsifying agent.

5. Fresh pasta filata cheese according to claim 1, wherein the at least one vegetable oil is selected from rice oil, corn oil, olive oil, preferably rice oil.

6. Fresh pasta filata cheese according to claim 3, wherein the at least one structuring agent is selected from fructans, gums and hydrocolloids, preferably fructans, more preferably the at least one structuring agent is inulin.

7. Fresh pasta filata cheese according to claim 4, wherein the at least one emulsifying agent is selected from soy milk, soy lecithin, mono- and di-glycerides of fatty acids, preferably soy milk.

8. Process for producing a fresh pasta filata cheese with a fat content equal to or lower than 0.5% w/w, comprising the following steps:
i) preparing an emulsion by mixing at least one vegetable oil and at least one emulsifying agent;
ii) mixing the emulsion with fully skimmed milk;
iii) acidifying the mixture of step ii) to obtain an acidified mixture;
iv) coagulating the acidified mixture to obtain a curd;
v) processing the curd to obtain a fresh pasta filata cheese with a fat content equal to or lower than 0.5% w/w.

9. Process according to claim 8, wherein in step i) the at least one emulsifying agent is present in an amount between 40 and 55% by weight and the at least one vegetable oil is present in an amount between 25 and 45% by weight with respect to the total weight of the mixture,

10. Process according to claim 8, wherein in step i) at least one structuring agent is added, the at least one structuring agent being present in an amount between 15 and 25% by weight with respect to the total weight of the mixture.

11. Process according to claim 8, wherein in step ii) the emulsion is mixed with fully skimmed milk in an amount between 2.5 and 5% by weight with respect to the fully skimmed milk volume.

12. Process according to claim 8, wherein in step iii) the addition of a) an acidifying agent and/or b) a microbial culture is provided.

13. Process according to claim 8, wherein the coagulation step iv) is carried out by adding liquid rennet to the acidified mixture obtained in step iii).
